(19) United States
(12) Patent Application Publication
(10) Pub. No.: US 2025/0337740 A1
(43) Pub. Date: Oct. 30, 2025

(54) ENHANCED PROTECTION FOR WEB USERS VIA ADDITIONAL CROSS-ORIGIN RESOURCE SHARING VALIDATION

(71) Applicant: CISCO TECHNOLOGY, INC., San Jose, CA (US)

(72) Inventor: Pete RAI, Egham (GB)

(21) Appl. No.: 18/645,653

(22) Filed: Apr. 25, 2024

(51) Int. Cl. H04L 9/40

(52) U.S. Cl. CPC H04L 63/10

(57) ABSTRACT

In one embodiment, a method for detecting restricted cross-origin requests by a webpage is provided. The method includes: receiving, by a processor, webpage data associated with the webpage; determining, by the processor, a presence of cross-origin uniform resource locator (URL) data from the webpage data; in response to cross-origin URL data being present, generating, by the processor, an independent request for a resource directly to a server associated with the cross-origin URL; determining, by the processor, whether the resource was restricted by the server; and selectively generating, by the processor, mitigation data to mitigate presentation of the restricted resource associated with the cross-origin URL data.

### TECHNICAL FIELD

The present disclosure relates generally to internet security systems and more particularly to security systems for mitigating the effects of cross-origin resource sharing of resources that have been restricted.

### BACKGROUND

Cross-Origin Resource Sharing (CORS) is an HTTP-header based mechanism that allows a server to indicate any origins (domain, protocol, or port) other than its own from which a browser should permit loading of its hosted resources. CORS includes a browser implemented mechanism that makes a preflight request to the server hosting the cross-origin resource, in order to check that the server will permit the actual request. The preflight request includes headers that indicate the origin information of the webpage that will be making the actual request.

CORS has many uses including mitigating security vulnerabilities like cross-site request forgery (CSRF) and cross-site scripting (XSS) attacks, maintaining data isolation between different websites and web applications, and ensuring that a web page or application hosted on one domain cannot arbitrarily access or modify resources on another domain. CORS also allows for third-party integrations of services or APIs into a web application or resource sharing of images, fonts, or videos hosted on a different domain, by permitting cross-origin requests for specific resources.

In some instances, a bad actor may attempt to circumvent the CORS protection in order to obtain restricted resources. For example, CORS operates within browser contexts and resources can still be obtained through non-browser based network requests. A bad actor may configure a server-side proxy to obtain the restricted cross-origin resource through a non-browser based request. For example, rather than making a cross-origin request within the webpage, the bad actor configures the web page to, instead, send the target URL to another server which is either on the same domain as the webpage or another domain that is allowed or not protected by CORS. Such other servers are trivial to create and can often be a simple serverless lambda function. The other server can then request the resource on behalf of its client and return the resource to the requesting browser. Since the other server is not running within a browser context, the other server obtains the resource without CORS being applied.

Accordingly, it is desirable to provide improved methods and systems for detecting cross-origin requests of restricted resources which are attempting to bypass or defeat the CORS mechanisms. Furthermore, other desirable features and characteristics of the present disclosure will become apparent from the subsequent detailed description and the appended claims, taken in conjunction with the accompanying drawings and the foregoing technical field and background.

### BRIEF DESCRIPTION OF THE DRAWINGS

In order that the disclosure may be well understood, there will now be described various forms thereof, given by way of example, reference being made to the accompanying drawings, in which:

FIG. 1 is a functional block diagram illustrating an example computing system having a cross-origin resource sharing system in accordance with various embodiments;

FIGS. 2, 3, and 4 are dataflow diagrams illustrating an example cross-origin resource sharing system in accordance with various embodiments; and

FIG. 5 is a flowchart illustrating an example cross-origin resource sharing method or process that may be performed by the cross-origin resource sharing system in accordance with various embodiments.

### DESCRIPTION OF EXAMPLE EMBODIMENTS

The following description is merely exemplary in nature and is not intended to limit the present disclosure, application, or uses. It should be understood that throughout the drawings, corresponding reference numerals indicate like or corresponding parts and features. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality. As used herein the term cross-origin refers to an origin defined by a protocol, a path, and a port that is different than an origin defined by a protocol, a path, and a port associated with a webpage.

### Overview

According to various embodiments, methods, systems, and computer program products are provided for detecting restricted cross-origin requests by a webpage. The method includes: receiving, by a processor, webpage data associated with the webpage; determining, by the processor, a presence of cross-origin uniform resource locator (URL) data from the webpage data; in response to cross-origin URL data being present, generating, by the processor, an independent request for a resource directly to a server associated with the cross-origin URL; determining, by the processor, whether the resource was restricted by the server; and selectively generating, by the processor, mitigation data to mitigate presentation of the restricted resource associated with the cross-origin URL data.

### Example Embodiments

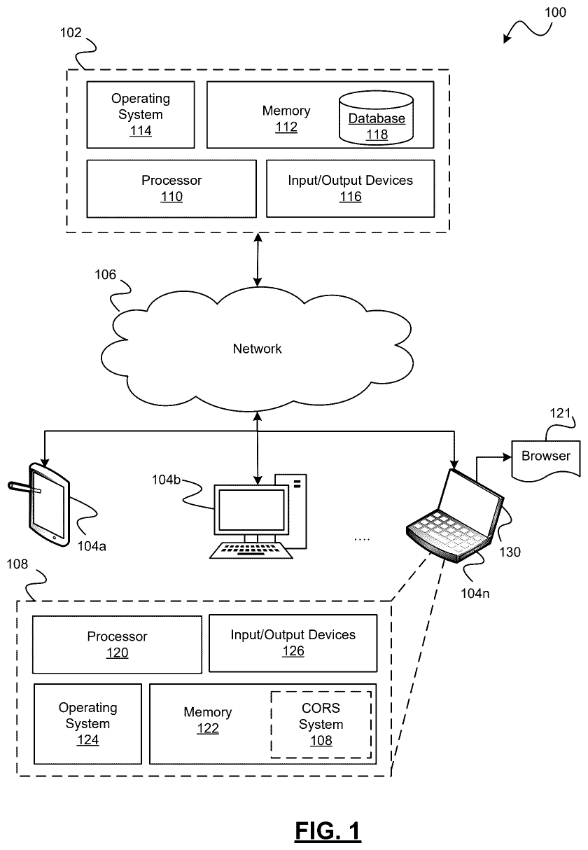

With reference to FIG. 1, an exemplary computer environment is shown generally at 100 having a server system 102 of one or more servers that are communicatively coupled to one or more computer systems 104a-104n through a network 106. The computer environment 100 is shown having a cross-origin resource sharing system 108 in accordance with various embodiments. As can be appreciated, the cross-origin resource sharing system 108 disclosed herein may be located on the computer systems 104a-104n, located on the server system 102, located on a device or node of the network 106, or distributed between any of the server system 102, the computer systems 104a-104n, and one or more devices or nodes of the network 106. For exemplary purposes, the disclosure will be discussed in the context of the cross-origin resource sharing system 108 being implemented on at least one of the one or more computer systems 104a-104n, for example, as part of or an extension of a browser or browser application.

In various embodiments, server system 102 includes one or more servers that store and make available dynamic web resource or resources, commonly referred to as resources, to users of the computer environment 100. In some instances, the use of all or parts of the resources may be restricted by a cross-origin resource sharing (CORS) file. For example, certain resources may be restricted for use by domain only users. Such restriction may be performed by configuring the cross-origin resource sharing file associated with the resource.

As can be appreciated, the server system 102 generally operates with any sort of conventional processing hardware, including, but not limited to, at least one processor 110, memory 112, an operating system 114, an input/output device 116, and a database 118 that stores the resources. The processor 110 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 112 represents any non-transitory short- or long-term storage or other computer-readable media capable of storing programming instructions for execution on the processor 110, including any sort of random access memory (RAM), read only memory (ROM), flash memory, magnetic or optical mass storage, and/or the like. The computer-executable programming instructions, when read and executed by the processor 110, cause the processor 110 to create, generate, or otherwise facilitate the communication of the resources and perform one or more additional tasks, operations, functions, and/or processes described herein. In various embodiments, the memory 112 includes the database 118 that stores the resources. As can be appreciated, the memory 112 represents one suitable implementation of such computer-readable media, and alternatively or additionally, the processor 110 could receive and cooperate with external computer-readable media that is realized as a portable or mobile component or application platform, e.g., a portable hard drive, a USB flash drive, an optical disc, or the like.

The operating system 114 includes computer-executable programming instructions, when read and executed by the processor 110, cause the processor 110 to operate the computer system's basic functions such as scheduling tasks, executing applications, memory allocation, and controlling the input/output devices 116. The input/output devices 116 generally represents the interface(s) to networks (e.g., to the network 106, or any other local area, wide area, or other network), mass storage, display devices, data entry devices, and/or the like.

In various embodiments, the network 106 generally includes interconnected network nodes that are arranged according to one or more of a variety of network topologies and that are configured to communicate data according to one or more communication protocols. The network nodes can include, for example, network interface controllers, repeaters, hubs, bridges, switches, routers, firewalls, modems, etc. The network nodes may be interconnected based on physically wired, optical, and/or wireless radio-frequency topologies.

Each of the one or more computer systems 104a-104n (referred to generally as the computer system 104) generally includes any sort of personal computer, mobile telephone, tablet, or other network-enabled client device on the network 106. As can be appreciated, the computer system 104 generally operates with any sort of conventional processing hardware, including but not limited to, at least one processor 120, memory 122, an operating system 124, an input/output device 126. The processor 120 may be implemented using any suitable processing system, such as one or more processors, controllers, microprocessors, microcontrollers, processing cores and/or other computing resources spread across any number of distributed or integrated systems, including any number of “cloud-based” or other virtual systems.

The memory 122 represents any non-transitory short- or long-term storage or other computer-readable media capable of storing programming instructions for execution on the processor 120, including any sort of random access memory (RAM), read only memory (ROM), flash memory, magnetic or optical mass storage, and/or the like. The computer-executable programming instructions, when read and executed by the processor, cause the processor to create, generate, or otherwise facilitate the operations, functions, and/or processes described herein. It should be noted that the memory 122 represents one suitable implementation of such computer-readable media, and alternatively or additionally, the processor 120 could receive and cooperate with external computer-readable media that is realized as a portable or mobile component or application platform, e.g., a portable hard drive, a USB flash drive, an optical disc, or the like. The memory 122 may store the cross-origin resource sharing system 108 in various embodiments.

The operating system 124 includes computer-executable programming instructions, when read and executed by the processor 120, cause the processor 120 to operate the computer system's basic functions such as scheduling tasks, executing applications, memory allocation, and controlling input/output devices. The input/output device 126 generally represents the interface(s) to networks (e.g., to the network 106, or any other local area, wide area, or other network), mass storage, display devices, data entry devices and/or the like.

In an exemplary embodiment, the computer system 104 (e.g., 104n) includes or communicates with a display device 130, such as a monitor, screen, or another conventional electronic display. The display device 130 is configured to display a browser 121. The browser 121 or browser application is configured to present the resources retrieved from the server system 102 or other internet device via the network 106. The browser 121 or browser application integrates the cross-origin resource sharing system 108 to prevent or mitigate the presentation of the resources that have been restricted by a cross-origin resource sharing file.

According to a typical use case, a user operates the conventional browser 121 or browser application or other client program such as an application executed by the computer system 104 to contact the server system 102 via the network 106 using a networking protocol, such as the hypertext transport protocol (HTTP) or the like. A web page is viewed by the user, as desired via the browser 121 via the display device 130. In various embodiments, the cross-origin resource sharing system 108 operates to prevent presentation to the user or mitigate the effects of presentation to the user of any restricted resources.

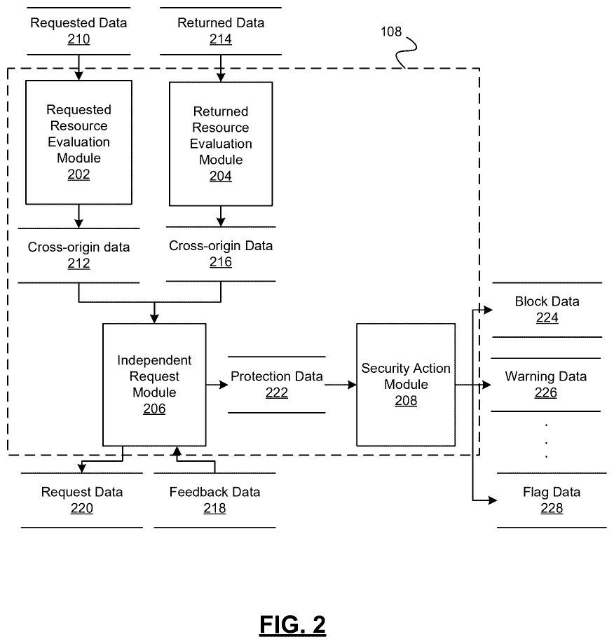

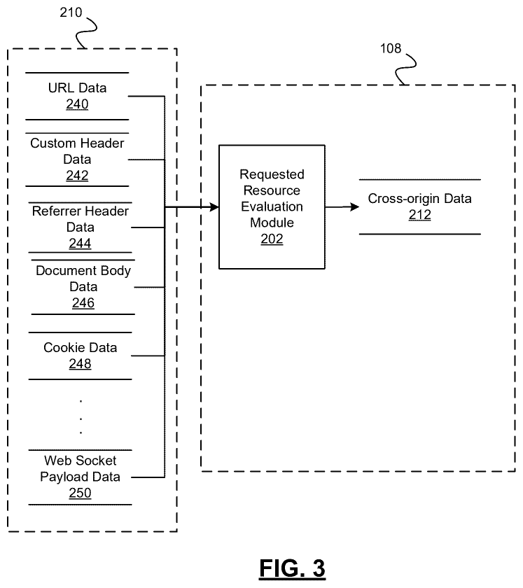

With reference now to FIG. 2, a dataflow diagram illustrates the cross-origin resource sharing system 108 in accordance with various embodiments. As can be appreciated, various exemplary embodiments of the cross-origin resource sharing system 108, according to the present disclosure, may include any number of modules and/or sub-modules. In various exemplary embodiments, the modules and sub-modules shown in FIG. 3 may be combined and/or further partitioned to similarly prevent restricted resources from being presented to a user. In various embodiments, the cross-origin resource sharing system 108 includes a requested resource evaluation module 202, a returned resource evaluation module 204, an independent request module 206, and a security action module 208.

In various embodiments, the modules 202-208 are configured to run within an existing privileged mode within the browser 121. For example, modern browsers operate security modes whereby the webpage is “sandboxed” and hence restricted from accessing key information such as the local file system, wider user browser history, etc. The browser 121 is aware of the entire context and operates in a “privileged mode.” Browser plug-ins are components which can be added to a browser installed instance by an end-user. Browser plug-ins are typically components vetted by the browser developing organization, but they can also be ad hoc components. Such plug-ins can run within a privileged mode which is greater than the webpage and ultimately at the same level as the browser 121. The permissions of each plug-in are generally granted at install time. Hence, they also have access to code or script language including, for example, a Fetch, XMLHttpRequest, or other such JavaScript based web access methods.

In various embodiments, the requested resource evaluation module 202 receives as input requested data 210 from a webpage and evaluates the requested data 210 for any outgoing requests for a cross-origin resource from a server. For example, as shown in more detail in FIG. 3, the requested data 210 can include, but is not limited to, URL data 240, custom header data 242, referrer header data 244, document body data 246, cookie data 248, and web socket payload data 250. Such data 210 can include a request for a cross-origin resource, thus the requested resource evaluation module 202 evaluates the data 240-250 using, for example, a lexical analyzer for requests of a server of a cross-origin uniform resource locator (URL). For example, the cross-origin URL may be present in the URL resource parameters, the URL path, or the document body using standard coding techniques (e.g., http://myproxy.mydomain.com?url=http://www.cisco.com/some-resource). The requested resource evaluation module 202 provides any identified cross-origin URLs and any associated parameters as cross-origin URL data 212.

With reference back to FIG. 2, in various embodiments, the returned resource evaluation module 204 receives returned data 214 including resources returned from the server system 102. The returned resource evaluation module 204 similarly evaluates the returned data 214 for any cross-origin URL information.

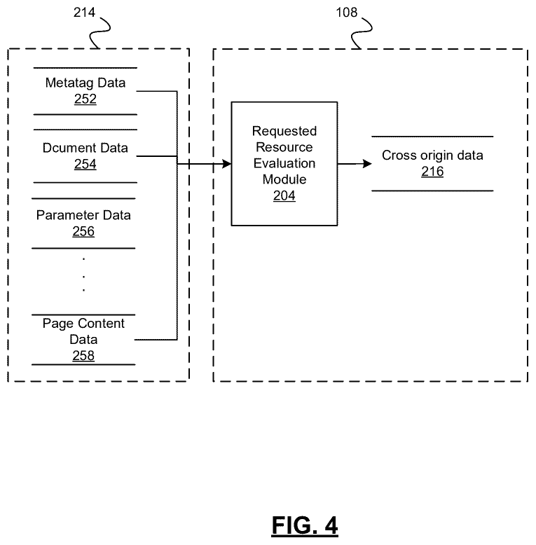

For example, as shown in FIG. 4, the returned data 214 can include, but is not limited to, metatag data 252, document data 254, parameter data 256, and page content data 258. The returned resource evaluation module 204 evaluates the data 252-258, using, for example, a lexical analyzer for indications of the data being returned from a server associated with a cross-origin uniform resource locator (URL). For example, the returned resource evaluation module 204 evaluates metatags associated with or the document itself such as, but an HTML text, plain text, or a Json application document to determine if the source URL of the returned resource is listed as a canonical, a short, or other such well understood meta attributes (e.g., <link rel=“canonical” href=“https://www.cisco.com/some-rsource”/>). The returned resource evaluation module 204 then determines if the source URL is a cross-origin URL when compared with the associated client and server in the examined exchange and generates cross-origin URL data 216 based thereon. As can be appreciated, other scenarios may exist, where resources have entered the browser 121 or browser application via an indirect request for the canonical location of that resource as the disclosure is not limited to the present examples.

With reference back to FIG. 2, in various embodiments, the independent request module 206 receives the cross-origin URL data 212, 216 and, for each identified cross-origin URL, makes an independent, direct request for the same resource from within its own privileged security context. For example, the independent request module 206 generates request data 220 directly to the appropriate server system 102 for the same resource and evaluates any feedback data 218. The request data 220 is defined to mirror the semantics of the source request, such as the HTTP method, headers, etc.

The independent request module 206 evaluates the feedback data 218 to determine if the target resource is protected by security parameters in a CORS file. The independent request module 206 generates protection data 222 for each identified cross-origin URL indicating whether the cross-origin URL is protected or not protected.

The security action module 208 receives as input the protection data 222. The security action module 208 performs one or more actions based on the input. These actions can include, but are not limited to, generating block data 224 to block the request by removing the payload from the response, generating warning data 226 to warn the user of a potential security violation, and/or generate flag data 228 to flag the webpage for further analysis by security professionals.

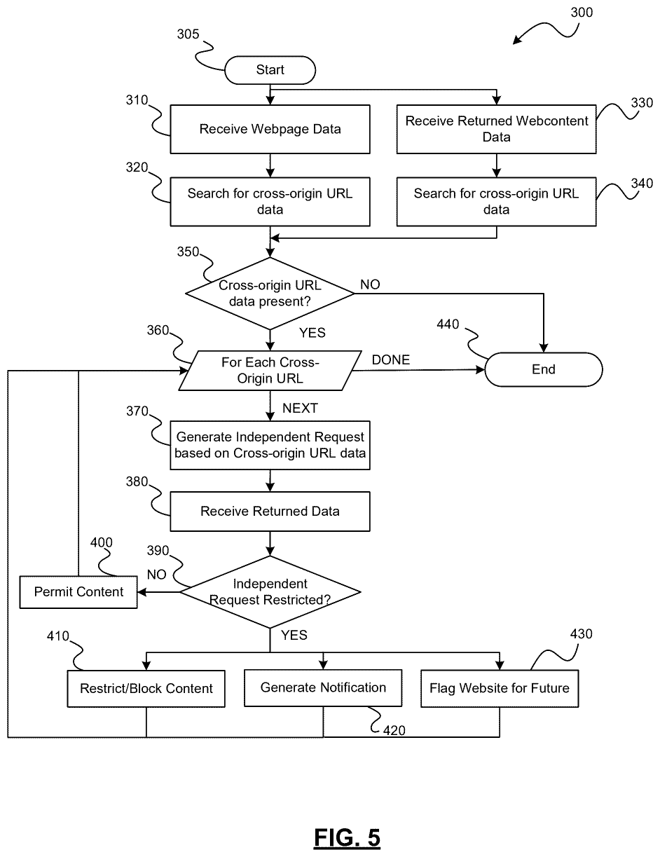

With reference now to FIG. 5 and with continued reference to FIGS. 1-4, a process flowchart illustrating an example process 300 for preventing presentation of restricted resources on the internet as performed by the cross-origin resource sharing system 108 is shown in accordance with various embodiments. As can be appreciated in light of the disclosure, the order of operations performed by the process 300 is not limited to the sequential execution as illustrated in FIG. 5 but may be performed in one or more varying orders as applicable and in accordance with the present disclosure. In various embodiments, the process 300 can be scheduled to run based on one or more predetermined events or run automatically based on an occurrence of one or more events.

In one example, the process 300 may begin at 305. The requested data 210 is received including any HTML code, scripts, or other resources of a webpage at 310. The requested data 210 is analyzed, for example by the requested resource evaluation module 202, to identify any cross-origin URL data 212 at 320.

At the same time or thereafter, the returned data 214 including any documents with metadata is received at 330. The returned data 214 is analyzed, for example by the returned resource evaluation module 204, to identify any cross-origin URL data 216 in the metadata at 340.

Thereafter, it is determined whether any cross-origin URL data 212 and/or 216 has been identified at 350. If no cross-origin URL data 212 or 216 has been identified at 350, the process 300 may end at 440. If, however, cross-origin URL data 212 and/or 216 is identified at 350, for each cross-origin URL in the cross-origin URL data 212 and/or 216 at 360, an independent request for the resource is made, for example, by the independent request module 206, directly to the origin of the server system 102 via request data 220 at 370. In response to the request, feedback data 218 is received at 380 and evaluated at 390.

If, at 390, the request for cross-origin data was not restricted by, for example, a CORS file, the returned resource is permitted to be presented to the user via the browser 121 at 400 and the process 300 continues with the next cross-origin URL in the cross-origin URL data 212 and/or 216 at 360. If, however, the request for cross-origin data was restricted by, for example, a CORS file at 390, one or more of the security actions, for example by the security action module 208, are taken at 410, 420, and/or 430. For example, the resource is restricted or blocked from being presented to the user via the block data 224 at 410, a notification including a warning of the unauthorized resource is generated to notify the user via the warning data 226 at 420, and/or the webpage is flagged for security purposes via the flag data 228 at 430.

Thereafter, the process 300 continues with the next cross-origin URL in the cross-origin URL data 212 and/or 216 at 360. Once all cross-original URLs have been processed at 360, the process 300 may end at 440.

The systems and methods presented herein have the effect of significantly complicating the problems bad actors face when attempting to obtain restricted resources.

As used herein, the phrase at least one of A, B, and C should be construed to mean a logical (A OR B OR C), using a non-exclusive logical OR, and should not be construed to mean “at least one of A, at least one of B, and at least one of C.”

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for detecting restricted cross-origin requests by a webpage, comprising:
receiving, by a processor, webpage data associated with the webpage;
determining, by the processor, a presence of cross-origin uniform resource locator (URL) data from the webpage data;
in response to cross-origin URL data being present, generating, by the processor, an independent request for a resource directly to a server associated with the cross-origin URL;
determining, by the processor, whether the resource was restricted by the server; and
selectively generating, by the processor, mitigation data to mitigate presentation of the restricted resource associated with the cross-origin URL data.

2. The method of claim 1, wherein the cross-origin URL data includes a cross-origin URL, wherein the cross-origin URL includes at least one of a protocol, a path, and a port that is different than at least one of a protocol, a path, and a port associated with the webpage.

3. The method of claim 2, wherein the determining the presence of the cross-origin URL data comprises analyzing, by the processor, requested data from the webpage data to determine if any cross-origin uniform resource locators are recited.

4. The method of claim 3, wherein the webpage data includes HTML code.

5. The method of claim 3, wherein the webpage data includes script code.

6. The method of claim 2, wherein the determining the presence of the cross-origin URL data comprises analyzing, by the processor, at least one returned resource associated with the webpage data to determine if any cross-origin URLs are recited.

7. The method of claim 6, wherein the analyzing comprises analyzing metadata of the returned resource.

8. The method of claim 7, wherein the returned resource comprises at least one of HTML text, plain text, and a Json application.

9. The method of claim 7, wherein the metadata comprises a URL listed as at least one of a canonical and a short.

10. The method of claim 1, wherein the mitigation data includes notification that notifies a user of the restricted resource.

11. The method of claim 1, wherein the mitigation data includes display restriction data that restricts the display of the restricted resource.

12. The method of claim 1, wherein the mitigation data includes flag data that associates a security flag with the webpage.

13. A system for detecting restricted cross-origin requests by a webpage, comprising:
one or more processors; and
a computer-readable storage medium storing instructions which,
when executed by the one or more processors, cause the one or more processors to:
receive webpage data associated with the webpage;
determine a presence of cross-origin uniform resource locator (URL) data from the webpage data;
in response to cross-origin URL data being present,
generate an independent request for a resource directly to a server associated with the cross-origin URL;
determine whether the resource was restricted by the server; and
selectively generate mitigation data to mitigate presentation of the restricted resource associated with the cross-origin URL data.

14. The system of claim 13, wherein the cross-origin URL data includes a cross-origin URL, wherein the cross-origin URL includes at least one of a protocol, a path, and a port that is different than at least one of a protocol, a path, and a port associated with the webpage.

15. The system of claim 14, wherein the one or more processors determine the presence of the cross-origin URL data by analyzing requested data from the webpage data to determine if any cross-origin uniform resource locators are recited.

16. The system of claim 15, wherein the webpage data includes at least one of HTML code, and script code.

17. The system of claim 14, wherein the one or more processors determine the presence of the cross-origin URL data by analyzing at least one returned resource associated with the webpage data to determine if any cross-origin URLs are recited.

18. The system of claim 17, wherein the one or more processors analyze by analyzing metadata of the at least one returned resource, wherein the at least one returned resource comprises at least one of HTML text, plain text, and a Json application, and wherein the metadata comprises a URL listed as at least one of a canonical and a short.

19. The system of claim 13, wherein the mitigation data includes at least one of notification data that notifies a user of the restricted resource, display restriction data that restricts the display of the restricted resource, and flag data that associates a security flag with the webpage.

20. A non-transitory, tangible computer-readable storage device storing instructions for detecting restricted cross-origin requests by a webpage which, when executed by one or more processors, cause the one or more processors to:
receive webpage data associated with the webpage;
determine a presence of cross-origin uniform resource locator (URL) data from the webpage data;
in response to cross-origin URL data being present,
generate an independent request for a resource directly to a server associated with the cross-origin URL;
determine whether the resource was restricted by the server; and
selectively generate mitigation data to mitigate presentation of the restricted resource associated with the cross-origin URL data.
